(19) United States
(12) Patent Application Publication
(10) Pub. No.: US 2007/0151350 A1
(43) Pub. Date: Jul. 5, 2007

(54) Measuring fluid volumes in a container using pressure

(75) Inventor: Michael L. Sheldon, Georgetown, TX (US)

Correspondence Address: MARSHALL, GERSTEIN & BORUN LLP (FISHER), 233 SOUTH WACKER DRIVE, 6300 SEARS TOWER, CHICAGO, IL, 60606, US

(73) Assignee: FISHERJ-ROSEMOUNT SYSTEMS, INC., Austin, TX (US)

(21) Appl. No.: 10/545,117

(22) PCT Filed: Jan. 26, 2004
(86) PCT No.: PCT/US04/02045

§ 371 Date: May 22, 2006

Related U.S. Application Data
(60) Provisional application No. 60/446,169, filed on Feb. 10, 2003.

(51) Int. Cl. G01L 7/10

(52) U.S. Cl. 73/729.2

(57) ABSTRACT

A fluid meter disclosed herein comprises a container that can be pressurized, means for driving the pressure within the container to a predetermined pressure, a sensor for measuring the pressure within the container and indicating when the predetermined pressure is reached, a timer for measuring the amount of time it takes for the container to reach the predetermined pressure, and means for determining the volume of fluid within the container based on the time it took to drive the pressure within the container to the predetermined pressure.

### CROSS REFERENCE TO RELATED APPLICATIONS

This application claims priority from U.S. Provision Application Ser. No 60/446,169 filed on Feb. 10, 2003 with the same title.

### FIELD OF THE INVENTION

The present system and method relates to a fluid meter. More specifically, the present meter measures the amount of fluid in a container of a known volume by measuring how long it takes to drive the pressure within the container to a predetermined pressure.

### BACKGROUND

A relatively inexpensive method or system is desirable for measuring fluid in a container having a known volume. In process applications, fluid is often temporarily stored in container for later use. Typically, the amount of fluid in the container is measured by either visually looking at the level in the container or using some form of level indicator. Remotely monitoring these levels often require expensive electronic level indicators such as capacitive or resistive level indicators, which are currently available and costs hundreds of dollars. In other applications, fluid is stored briefly in a container as a part of a process and measurement is desirable, but no measurement is made. For example, fluid can be pumped in the container or it can be collected as described in U.S. patent application Ser. No. 10/106,655 entitled “An Apparatus for Extracting Oil or Other Fluids From a Well” by Philip Eggleston, filed on Mar. 26, 2002 and hereby incorporated by reference. As described in the referenced patent application, approximately 3 to 5 gallons of oil is collected at a time in a canister deep in an oil well before it is brought to the surface. The amount of fluid that the canister can hold is known. Once the container reaches the surface, the fluid is pumped into a pipeline using a compressor that pressurizes the container thereby forcing the fluid to be pushed up through a tube extending along the inside of the canister. In other words, as pressurized air enters the canister, oil is forced up the tube and out of the canister. From the canister, oil is transported to a tank battery using a flow pipeline. It is desirable to know the amount of fluid actually recovered with each cycle before its contents are pumped into the flow pipeline and without disrupting the process. For example, if the amount recovered is known, each cycle can be tuned to recover the maximum oil for each cycle or recover oil at the recovery rate of the well. Similarly, there are a lot of other processes where there are no easy, inexpensive, disruptive way to measure fluid in a container.

### BRIEF DESCRIPTION OF THE DRAWINGS

The present disclosure is best understood from the detail description and the accompanying drawings, in which:

FIG. 1 is a schematic diagram illustrating one possible fluid meter system according to the teachings of the below detailed description that could be used to measure fluid in a container.

### DETAIL DESCRIPTION OF THE INVENTION

Generally, fluid used in a process or created as a result of a process is placed in a container having a known volume at one time or another for storage. Before it is pumped from the container, knowing the amount of fluid is desirable for many reasons including metering the amount of fluid created by the process or knowing if there is enough of that fluid to start and finish a process. The present disclosure described in greater detail below provides an inexpensive method or system for measuring its volume. Basically, the volume of fluid is determined by measuring the affects of pressurizing the remaining volume in the container not occupied by fluid. The affect of pressurizing this remaining volume, which is predictable for known volumes, is used to determine the volume of fluid in the container. In other words, the amount of fluid in the container is determined by measuring the time it takes to compress the volume not filled with fluid to a predetermined pressure. Obviously, the fluid is preferably a non-compressible fluid, such as oil for example, or has a know compression rate.

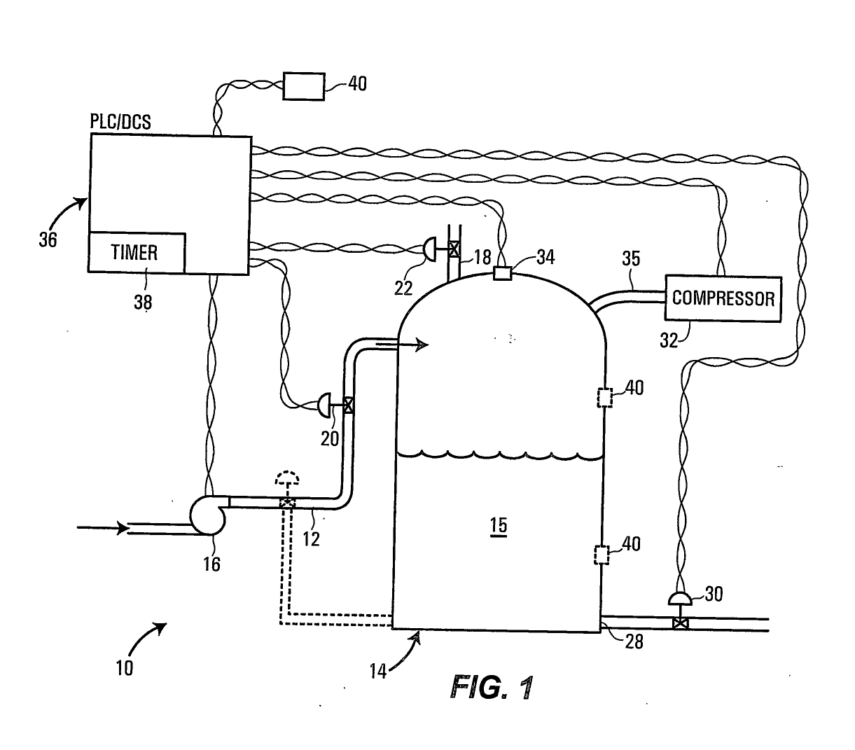

Referring now to FIG. 1, a process system 10 is illustrated showing fluid pumped through a pipe 12 (as indicated by arrows) into an enclosed container 14 by a pump 16. As the fluid enters the container, a vent 18 under the control of a solenoid valve 22 maybe provided to vent air that is displaced by incoming fluid. Once fluid 15 has been pumped into the container 14, a valve 20 is closed, terminating further flow into the container 14. One skilled in the art would appreciate that the pump may alternatively serve as a valve to terminate flow into or out of the container. This disclosure is not limited to type of pump or valve that may be used, providing that there is a relatively tight shut off to prevent further flow of fluid into or out of the container through the pipe 12. Further, pressurized air could serve as a pump as described in the Eggleston patent application referenced above. Once a measurement of the volume of fluid in the container is done, as will be described in greater detail below, fluid may either be pumped out of the container 14 using the same pump (as suggested by phantom lines) or by providing a separate drain 28 under the control of another valve 30. It is also possible that because of pressures down stream of the drain 28, a pressure regulator in combination with a check valve (not shown) could be used to regulate flow from the container.

A compressor 32 is also shown for providing compressed air into the container 14 and will be used in combination with a pressure switch 34 to meter the amount of fluid in the container once the fluid to be stored in the container 14 has been pumped, poured, or in some way placed into it. The pressure switch 34 is preferably place at the top of the container and use to determine when the interior of the container reaches a predetermined pressure when compressed air is pumped into the container by the compressor. Alternatively, the pressure switch 34 could be placed in the compressor's airline 35 feeding to the container 14. Pressure switches are widely available and relatively inexpensive, often only costing only a few dollars. The consistency of the pressure switch activating at the preferred pressure is important. Care should be taken in selecting a pressure switch that does not drift, since this will affect the accuracy of the measurements. Further, introducing compressed air uniformly from a compressed air reserve tank will also increase the accuracy of the measurement. For example, using a piston type of compressor without a reserve pressure tank could cause pulses of airflow into the container, which could prematurely trigger the pressure switch. In the alternative, a pressure sensor could be used and monitored to determine when a predetermined pressure has been reached.

Preferably all of the components are under the control of a controller 36 such as Programming Logic Controller (PLC) or a controller use in a distributive control system (DCS) as shown. Controller 36 is preferably equipped with a timer 38, which will be used to determine the time required to pressurize the container to the predetermined pressure. This time is related to volume of fluid in the container, as will be discussed further below. Controller timers are generally very accurate and can sample measurements in milliseconds. Otherwise a separate timer is needed and is preferably under the control of the controller. The time it take to pressurize the container to a predetermined pressure will vary depending on the predetermined pressure selected and the volume to be pressurized in the container. The speed at which the container is pressurized will directly affect the range of accuracy and the influence of variables such as temperature or small leaks that may exist. Preferably, the time it takes to pressurize the container to the predetermined pressure and the rate of the air introduced into the container to pressurize it short. For example, selecting the predetermined pressure and volume of pressurized air that is needed to pressurize the container when it is empty so that it takes under 20 seconds is desirable. However, depending on the circumstances and environment under which the measurements are taken, that time could be significantly increased. It should be noted that while decreasing the time helps eliminates unwanted variables such as temperature or leaks, it can also decreases the range of accuracy of the measurement, depending on the speed of the timer. Thus, one skilled in the art would understand that these variables would need to be accounted for when using this method of measuring fluid in their applications.

Referring back to the figure, the vent 18 is closed by way of the solenoid valve 22, as are the valves 20 and 30 that allow fluid into and out of the container. Closing the valves allows the container to become a pressurized container. As will be come apparent to one skilled in the art, a semi-pressurize container can also be used, if the pressure leaks are minimal and relatively constant. Once closed, the compressor pressurizes the container to a predetermined pressure, for example from 0 PSI to 20 PSI. As already mentioned, preferably the compressor operates uniformly by supplying a constant stream of pressurized air to the container. Almost any conventional, commercially available compressor can be used for this purpose. Generally any pressure will work, but increasing the pressure slightly, say around 5 PSI or even lower (depending on the resolution of the timer and the pressure switch as will be apparent below), results in faster measurements of fluid volume and is less influenced as a result of leaks or temperature. In some circumstances, using lower pressure may even result in more “real time” measurements and less disruption of the process.

The shape of the container will influence the time it take to pressurize it with different volumes of fluid in it, however, each container will have a predictable pressurized characteristic pattern for different volumes. For example, a column container, as shown, will generally show a linear relationship between the time it take to pressurize the container to a predetermined pressure and the level of fluid in it. The characteristics of other containers depend on how the volume level changes as fluid fills the container. For example, if the column container shown were laid on its side, it would fill differently (the change or rate in level change) because of the curvature of the wall of the canister and thus would have a different predetermined pressure time characteristic. Once the pressure characteristics of the container have been determined, the time it takes to reach a predetermined pressure can be directly correlated to the volume in the container. As one skilled in the art should realize from the details provide herein, the resolution of the volume measured, depends on the resolution of the sensor, the timer, and the actual pressure selected to pressurize the canister to for the measurement.

As an example, a column container similar to the one shown in FIG. 1 capable of holding 552 ounces was used to store fluid. Tests were conducted to determine the time characteristics of pressurizing it to a predetermined pressure of 20 PSI for various levels. The results showed that the time it took to pressurize the container to 20 PSI was nearly linear to the amount of fluid in the container. As a result, the following relationship was developed.
Tm=(Te−Tf)/(Ve−Vf)*Vm+Te
or
Vm=[(Tm−Te)/(Tf−Te)]*V,
where Tm is the time measured to achieve the desired predetermined pressure for an unknown volume, Te is the time measured when the container is empty, Tf is the time measured when the container is full, V is the volume of the container, and Vm is the measured volume.

In other words, the measured volume is a ratio of known and determined times as indicated. By way of further example using the 552-ounce container, it took approximately 42.75 seconds to pressurize the container to 20 PSI using a conventional inexpensive, portable compressor. The pressure switch used was from Barksdale and cost about 12 dollars. In another test it took 1.2 seconds to pressurize it to 20 PSI when it was full.

Using the relationship described above, a test with an unknown volume of fluid in the container took approximately 15.8 seconds to pressurize the container to 20 PSI. The volume of 358.04 fluid ounces contained in the container was found as follows:
Vm=(15.8 sec.−42.75 sec.)*[(0−552 ounces)/(42.75 sec.−1.2 sec.)]

Similarly, the volume of fluid in the container can be determined using the same principles describe above if the canister is already pressurized by measuring the time it takes to pressurize it to a different pressure, whether it is higher or lower.

From the above description, one skilled in the art would appreciate that other changes, substitutions, and alterations are also possible without departing from the spirit and scope of the above disclosure, drawing and following claims. For example, if a check valve is used to prevent downstream fluid from entering the container, a differential pressure sensor could be used to measure the differences of pressure downstream and the pressure in the container. The measured time it takes to reach the pressure to over come the downstream pressure could be used to measure the volume of fluid in the container. Further, the circumstance and size of the container may result in measurements being influenced by temperature. In these circumstances, a temperature sensor 40 could be used in conjunction with the measurements to offset these affects. The temperature sensor 40 could be located exterior to the canister to measure ambient temperature as shown in FIG. 1, interior to the canister to measure the temperature of the volume of air or fluid (as shown in phantom), or both. In the alternate, temperture compensated pressure sensors are available and could be used. Still further, it assumed that the fluid is non-compressible. However, the volume of some fluids can be determined using this method if the compression characteristics of the fluid are taken into account when the measurements are taken. Even still further, while the present disclosure describes a system that pressurizes the container, it should be understood by one skilled in the art that a vacuum could be introduced and the time it would take to reach a predetermined vacuum pressure could be used to measure the volume.

What is claimed is:

1. A fluid meter comprising:
a container that can be pressurized;
means for driving the pressure within the container to a predetermined pressure;
a sensor for measuring the pressure within the container and indicating when the predetermined pressure is reached;
a timer for measuring the amount of time it takes for the container to reach the predetermined pressure; and
means for determining the volume of fluid within the container based on the time it took to drive the pressure within the container to the predetermined pressure.

2. The fluid meter of claim 1 wherein the means for driving the pressure in the container to the predetermined pressure is a compressor with a reserve air tank.

3. The fluid meter of claim 1 wherein the sensor is a pressure switch set for the predetermined pressure.

4. The fluid meter of claim 1 wherein the means for driving the pressure, the sensor, and the timer are under the control of a controller.

5. The fluid meter of claim 1 further comprising a temperature sensor for measuring the ambient temperature outside the canister, interior of the canister, or both.

6. The fluid meter of claim 5 wherein the means for determining the volume of fluid within the canister uses the measured temperature detected by the temperature sensor to compensate for temperature affects when determining the measured volume.

7. A method of determining the volume of fluid in a canister comprising the steps of:
pressurizing a container to a predetermined pressure
measuring the time it takes to pressurize the container to the predetermined pressure, and
determining the amount of volume in the container based on the time it takes to pressurize the container to the predetermined pressure.
